(19) United States
(12) Patent Application Publication
(10) Pub. No.: US 2016/0053713 A1
(43) Pub. Date: Feb. 25, 2016

(54) Piston for Use in an Engine

(71) Applicant: Deere & Company, Moline, IL (US)

(72) Inventors: Richard E. Winsor, Waterloo, IA (US); Nam Hyo Cho, Cedar Falls, IA (US)

(21) Appl. No.: 14/462,753

(22) Filed: Aug. 19, 2014

(51) Int. Cl. F02F 3/28

(52) U.S. Cl. CPC F02F 3/28

(57) ABSTRACT

A piston for use in an engine. The piston includes a sidewall, a bowl, a tapered surface, and an outer surface. The tapered surface is positioned radially outward relative to the bowl, and the outer surface contacts the sidewall and is positioned radially outward relative to the tapered surface. The tapered surface extends between the bowl and the outer surface, such that the tapered surface contacts the bowl at a radially inward location and contacts the outer surface at a radially outward location. The sidewall faces radially outward to mate with a cylinder of the engine.

### FIELD OF THE DISCLOSURE

The present disclosure relates to a piston for use in an engine.

### BACKGROUND OF THE DISCLOSURE

An engine includes an engine block, a cylinder head, a combustion chamber, and a piston. Combustion events, in the combustion chamber, cause the piston to reciprocate along a rectilinear path within a cylinder. The combustion chamber is formed at an end of the cylinder, and is bound at a first end by the cylinder head and at a second end by a top of the piston. Known engines may have unnecessary heat losses, as a result of the flame during a combustion event being relatively hot compared to the piston and cylinder head. These heat losses result in lost energy that cannot be used for creating pressure in the combustion chamber and forcing the piston to reciprocate.

### SUMMARY OF THE DISCLOSURE

Disclosed is a piston for use in an engine. The piston includes a sidewall, a bowl, a tapered surface, and an outer surface. The tapered surface is positioned radially outward relative to the bowl, and the outer surface contacts the sidewall and is positioned radially outward relative to the tapered surface. The tapered surface extends between the bowl and the outer surface, such that the tapered surface contacts the bowl at a radially inward location and contacts the outer surface at a radially outward location. The sidewall faces radially outward to mate with a cylinder of the engine. In some embodiments and modes of the engine, the tapered surface lowers the amount of turbulence in the combustion chamber during a combustion event, particularly above the outer surface of the piston. This may result in lowering the amount of heat transfer from the flame to the piston, and from the flame to the cylinder head. This may also result in increased energy being used to create pressure in the combustion chamber for forcing the piston to reciprocate.

### BRIEF DESCRIPTION OF THE DRAWINGS

The detailed description of the drawings refers to the accompanying figures in which:

FIG. 1 is an illustration of an engine for use in a machine, the machine being shown as an agricultural tractor;

FIG. 2 is a perspective view of an example of a piston and a cylinder head, the piston being shown slightly below a top dead center position;

FIG. 3 is a central cross sectional view of the piston taken along lines 3-3 of FIG. 2, though in FIG. 3 the piston is shown in the top dead center position; and

FIG. 4 is a central cross sectional view of the piston, an intake valve, an exhaust valve, and a fuel plume.

Like reference numerals in the various drawings indicate like elements.

### DETAILED DESCRIPTION OF THE DRAWINGS

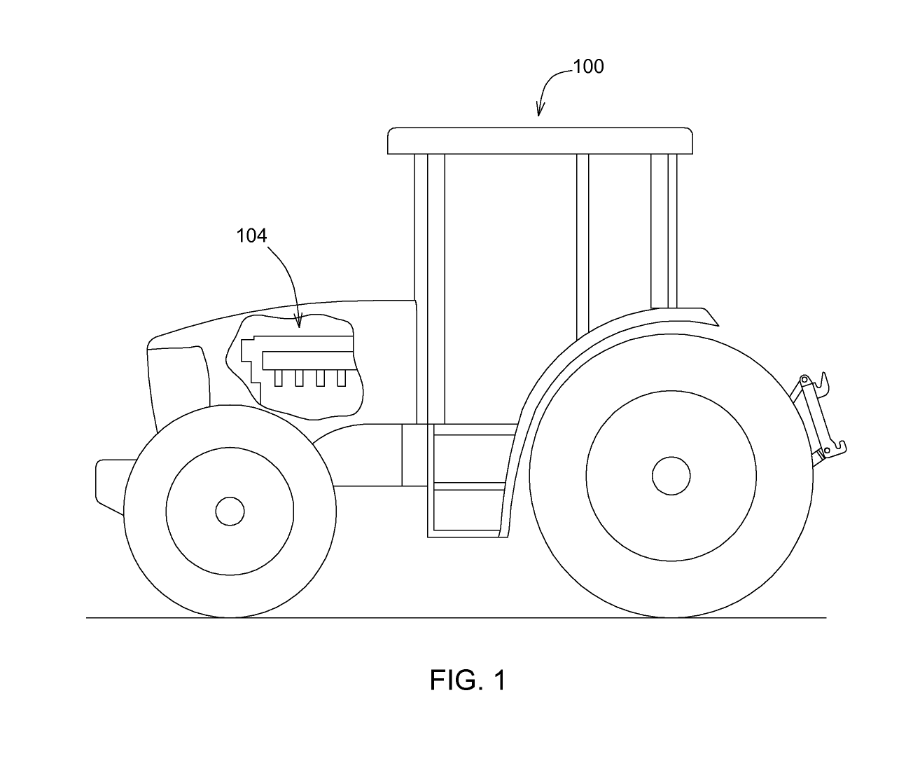

Referring to FIG. 1, there is shown an illustration of an engine 104 for providing power to a variety of machines, including on-highway trucks, construction vehicles, marine vessels, stationary generators, automobiles, agricultural vehicles, and recreational vehicles. In the illustrated embodiment, the machine 100 is an agricultural tractor. The engine 104 may be of any size, be of any configuration (e.g., “V,” inline, and radial), and have any number cylinders.

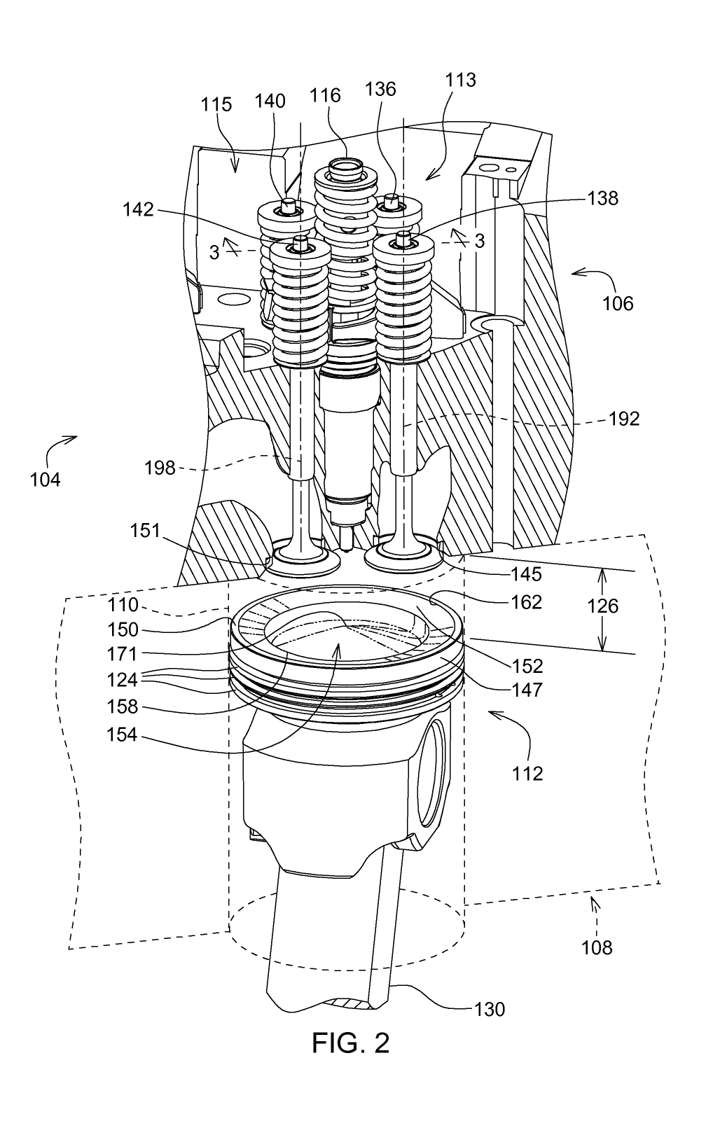

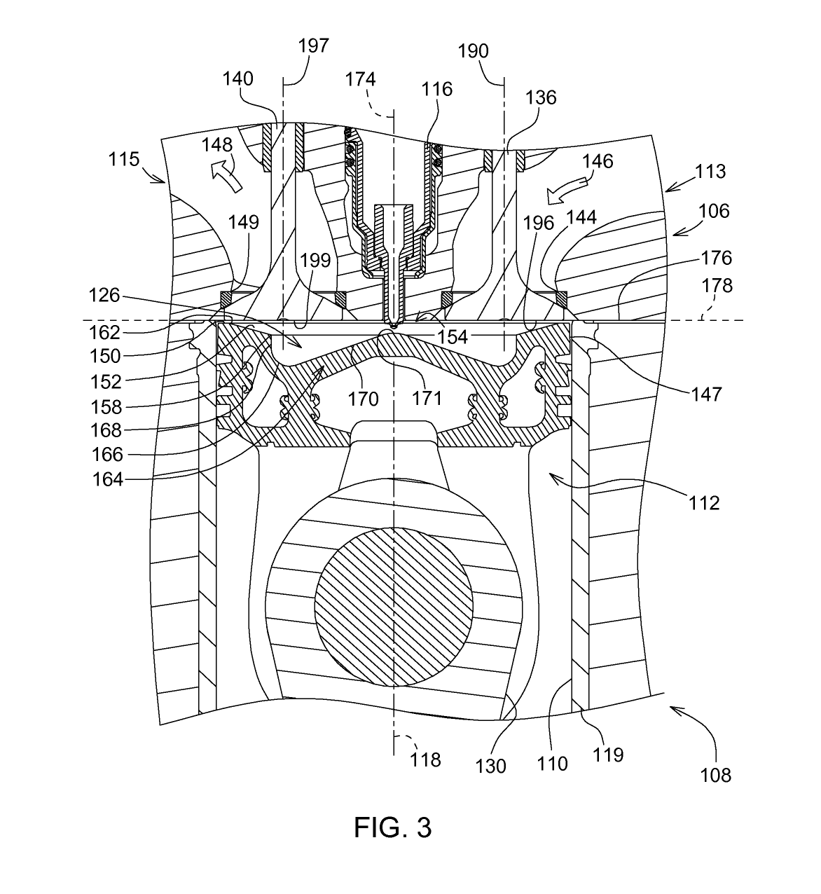

Next, referring to FIGS. 2 and 3, the engine 104 includes an engine block 108, a cylinder head 106, a combustion chamber 126, and a piston 112. The piston 112 is connected through a connecting rod 130 to a crankshaft of the engine 104. Combustion events cause the piston 112 to reciprocate along a rectilinear path within a cylinder 110, the cylinder 110 being partially formed by a sleeve 119, in at least some embodiments. The combustion chamber 126 is formed at the end of the cylinder 110, and is bound at a first end by the cylinder head 106 and at a second end by the top surface of the piston 112. A fuel injection nozzle 116 injects, for example, fuel into the combustion chamber 126.

The engine 104 may include an intake system 113, which includes components for introducing a fresh intake gas in the direction of arrow 146 (see FIG. 3) during intake strokes of the piston 112. Further, the engine 104 includes an exhaust system 115, which includes components for directing exhaust gas, from the engine 104 to the atmosphere, in the direction of arrow 148 (see FIG. 3) during exhaust strokes of the piston 112. The exhaust system 115 may include an aftertreatment system. And in such embodiments, at least some of the exhaust gas flows through the aftertreatment system, so that it can remove various chemical compounds and particulate emissions present in the exhaust gas.

The piston 112 includes a sidewall 147, an outer surface 150, a tapered surface 152, and a bowl 154. The tapered surface 152 is positioned radially outward relative to the bowl 154, and the outer surface 150 contacts the sidewall 147 and is positioned radially outward relative to the tapered surface 152. The tapered surface 152 extends between the bowl 154 and the outer surface 150, such that the tapered surface 152 contacts the bowl 154 at a radially inward location 158 and contacts the outer surface 150 at a radially outward location 162. The sidewall 147 may face radially outward to mate with the cylinder 110 of the engine 104. In some embodiments of the piston 112, the outer surface 150 may be a flat outer surface that defines a plane 156 that is perpendicular to a longitudinal piston axis 118 that intersects a center of the bowl 154. The tapered surface 152 may form an angle 160 of around 15°, as measured from the outer surface 150, as such an angle lower the amount of heat transfer from the flame to the piston 112, and from the flame to the cylinder head 106. The piston 112 may be symmetric about the piston axis 118 that intersects the center of the bowl 154.

The radially inward location 158 may be a radially inward circumferential edge that is defined by the bowl 154 and the tapered surface 152, and the radially outward location 162 may be a radially outward circumferential edge that is defined by the tapered surface 152 and the outer surface 150. The radially inward and outward circumferential edges are defined by two surfaces intersecting. The tapered surface 152 may be a frustoconical surface, and the outer surface 150 may be an annular surface, and in such embodiments, the frustoconical surface and the annular surface may intersect so as to define the radially outward location 162. In some embodiments and modes of the engine 104, the tapered surface 152 lowers the amount of turbulence in the combustion chamber 126 above the outer surface 150, during combustion events, resulting in a lower amount of heat transfer—particularly at top dead center—from the flame to the piston 112, and from the flame to the cylinder head 106. This decreased heat transfer may result in increased energy being used to create pressure in the combustion chamber 126 for forcing the piston 112 to reciprocate. This decreased heat transfer may also result in decreased thermal loading on piston 112 and the cylinder head 106.

A radius 182 of the radially inward location 158 is measured perpendicularly relative to the piston axis 118, and a radius 184 of the radially outward location 162 is also measured perpendicularly relative to the piston axis 118. A radius 186 of the piston 112 is measured perpendicularly from the piston axis 118 to where the outer surface 150 contacts the sidewall 147. The radius 182 of the radially inward location 158 may be between 60% and 80% of the radius 186 of the piston 112, while the radius 184 of the radially outward location 162 may be between 85% and 97% of the radius 186 of the piston 112.

The piston 112 may be of a variety of styles, including (but not limited to) an articulated piston, monobloc piston, forged piston, multi-piece piston, and other configurations known to those of ordinary skill in the art. The piston 112 may be formed of at least one of a metallic, intermetallic, ceramic, or composite material, so that the piston 112 can withstand the temperatures and pressures associated with the combustion events in the combustion chamber 126. The piston 112 further includes a plurality of piston ring grooves 124 for receiving piston rings therein. The location and number of the ring grooves 124 are not meant to be limiting, as pistons having other locations and numbers are also contemplated herein. The cylinder head 106, which includes an intake valve seat 144, is mounted to the engine block 108. The combustion chamber 126 is formed at least partially by the cylinder 110 and the cylinder head 106.

As illustrated in FIG. 3, the engine 104 may include an intake valve 136 and a second intake valve 138, though other embodiments may include only the intake valve 136, for example. The intake valve 136 is configured to travel between a fully closed position seated against the intake valve seat 144 and an opened position displaced from the intake valve seat 144 allowing an intake gas to flow through the intake valve seat 144 and into the combustion chamber 126. The cylinder head 106 includes a block mounting face 176 defining a block mounting plane 178, and the intake valve 136 defines an intake axis 190. The block mounting plane 178 and the intake axis 190 may be substantially perpendicular relative to one another. An intake face 196 of the intake valve 136 may overlap at least a portion of the tapered surface 152 and at least a portion of the outer surface 150, when viewed in a direction perpendicular to the intake face 196 of the intake valve 136.

The second intake valve 138 is configured to travel between a fully closed position seated against a second intake valve seat 145 and an opened position displaced from the second intake valve seat 145, allowing an intake gas to flow through the second intake valve seat 145 and into the combustion chamber 126. The second intake valve 138 defines a second intake axis 192, the block mounting plane 178 and the second intake axis 192 being substantially perpendicular relative to one another. The intake axis 190 and the second intake axis 192 may both be radially inward of the outer surface 150. An intake face of the second intake valve 138 may overlap at least a portion of the tapered surface 152 and at least a portion of the outer surface 150, when viewed in a direction perpendicular to the intake face of the second intake valve 138. In some embodiments, the intake valve 136 and the second intake valve 138 may be recessed up into the cylinder head 106, so as to provide alternative timing of the intake valve 136 and the second intake valve 138.

As further illustrated in FIG. 3, the engine 104 may include an exhaust valve 140 and a second exhaust valve 142, though other embodiments may include only the exhaust valve 140, for example. The exhaust valve 140 travels between a fully closed position seated against an exhaust valve seat 149 and an opened position displaced from the exhaust valve seat 149, thereby allowing the exhaust gas to flow out of the combustion chamber 126 and through the exhaust valve seat 149. The exhaust valve 140 defines an exhaust axis 197, and in the illustrated embodiment, the block mounting plane 178 and the exhaust axis 197 are substantially perpendicular relative to one another. An exhaust face 199 of the exhaust valve 140 may overlap at least a portion the tapered surface 152 and at least a portion of the outer surface 150, when viewed from a direction perpendicular to the intake face 196.

The second exhaust valve 142 travels between a fully closed position seated against a second exhaust valve seat 151 and an opened position displaced from the second exhaust valve seat 151, which allows the exhaust gas to flow through the second exhaust valve seat 151 and into the combustion chamber 126. The second exhaust valve 142 defines a second exhaust axis 198. The block mounting plane 178 and the second exhaust axis 198 are substantially perpendicular relative to one another, and the exhaust axis 197 and the second exhaust axis 198 are both radially inward of the outer surface 150 relative to the piston axis 118. An exhaust face of the second exhaust valve 142 may overlap at least a portion the tapered surface 152 and at least a portion of the outer surface 150, when viewed from a direction perpendicular to the intake face of the second exhaust valve 142. In some embodiments, the exhaust valve 140 and the second exhaust valve 142 may be recessed up into the cylinder head 106, so as to provide alternative timing of the exhaust valve 140 and the second exhaust valve 142.

Such orientations of the intake valves 136, 138 and the exhaust valves 140, 142 may maximize power production and may simultaneously minimize heat waste. In some embodiments, the orientation of the intake valves 136, 138, for example, encourages even combustion of the fuel over the piston 112. And the orientation of the exhaust valves 140, 142, for example, encourages an even and fast exhaust of the exhaust gas, so as to minimize heat waste via heat loss to the piston 112 and the cylinder head 106.

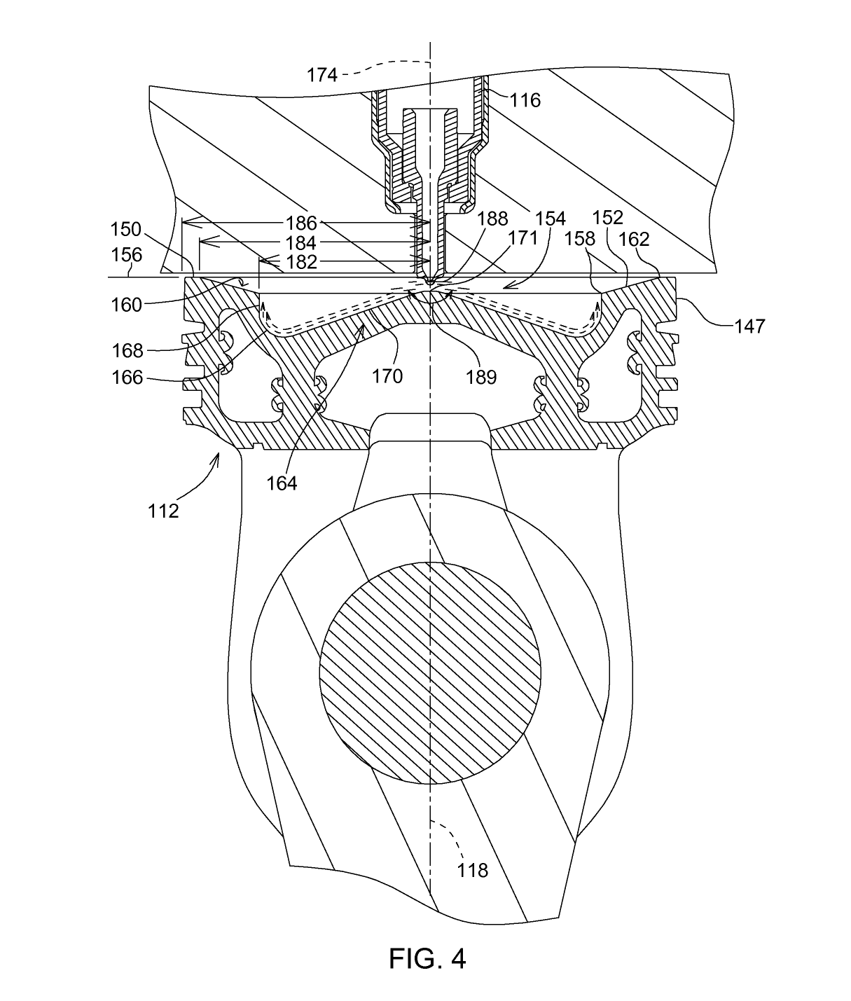

Referring to FIGS. 3-4, the bowl 154 may include a conically curved section 164, a recessed curved section 166, and a vertical wall section 168. The conically curved section 164 may include an inclined surface 170 and a peak 171. The recessed curved section 166 may be positioned radially outward relative to the conically curved section 164. The inclined surface 170 may become gradually lower as it extends radially from the peak 171 and radially toward the recessed curved section 166. A vertical wall section 168 may extend axially away from the recessed curved section 166 such that the vertical wall section 168 is in contact with the recessed curved section 166 and in contact with the tapered surface 152. Assuming that the bowl 154 faces axially upward, the radially inward location 158 may be positioned axially below the peak 171, and the radially outward location 162 may be positioned axially above the peak 171, both as viewed in a central cross sectional view of the piston 112, as shown in FIGS. 3-4.

The injection nozzle 116 is positioned in the cylinder head 106 for providing fuel to the combustion chamber 126. The injection nozzle 116 defines a nozzle axis 174 that may be substantially aligned with the piston axis 118. The injection nozzle 116 includes a plurality of spray apertures 188 that may periodically spray the fuel into, as shown in FIG. 4, a conical pattern measuring between 120° and 160° and, in some embodiments, in a conical pattern measuring between 135° and 145°, as indicated by angle 189. The injection nozzle 116 includes between 10 and 14 spray apertures 188 and specifically, in at least some embodiments, 12 spray apertures 188. The orientation of the injection nozzle 116 and the conical pattern encourages even combustion of the fuel, so as to maximize power distribution and, simultaneously, minimize heat waste to the combustion chamber 126. The engine 104 may include a controller that is configured to spray a single dose of fuel into the combustion chamber 126 prior to the piston 112 being in a top dead center position during an exhaust stroke (e.g., 10° prior to being in a top dead center position). The plurality of spray apertures 188 is configured to spray the single dose of fuel radially inward of the tapered surface 152 such that the single dose of fuel overlaps the bowl 154.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

1. A piston for use in an engine, the piston comprising:
a sidewall facing radially outward to mate with a cylinder of the engine;
a bowl;
a tapered surface positioned radially outward relative to the bowl; and
an outer surface contacting the sidewall and positioned radially outward relative to the tapered surface, the tapered surface extending between the bowl and the outer surface such that the tapered surface contacts the bowl at a radially inward location and contacts the outer surface at a radially outward location.

2. The piston of claim 1, wherein the outer surface is a flat outer surface that defines a plane that is perpendicular to a longitudinal piston axis that intersects a center of the bowl.

3. The piston of claim 1, wherein the radially inward location is a radially inward circumferential edge that is defined by the bowl and the tapered surface, and the radially outward location is a radially outward circumferential edge that is defined by the tapered surface and the outer surface.

4. The piston of claim 1, wherein the tapered surface is a frustoconical surface, and the outer surface is an annular surface, and the frustoconical surface and the annular surface intersect so as to define the radially outward location.

5. An engine comprising the piston of claim 1.

6. The piston of claim 1, wherein:
the tapered surface is a frustoconical surface;
the radially inward location is a radially inward circumferential edge that is defined by the bowl and the tapered surface;
the radially outward location is a radially outward circumferential edge that is defined by the tapered surface and the outer surface;
the outer surface is a flat outer surface that defines a plane that is perpendicular to a longitudinal piston axis that intersects a center of the bowl; and
the bowl comprises:
a conically curved section that comprises an inclined surface and a peak;
a recessed curved section positioned radially outward relative to the conically curved section, the inclined surface becomes gradually lower as it extends radially from the peak and radially toward the recessed curved section; and
a vertical wall section extending axially away from the recessed curved section such that the vertical wall section is in contact with the recessed curved section and in contact with the tapered surface.

7. The piston of claim 1, wherein the bowl faces axially upward, and the radially inward location is positioned axially below a peak of the bowl, as viewed in a central cross sectional view of the piston.

8. The piston of claim 7, wherein the radially outward location is positioned axially above the peak of the bowl, as viewed in the central cross sectional view of the piston.

9. A piston for use in an engine, the piston comprising:
a bowl;
a tapered surface positioned radially outward from the bowl; and
a flat outer surface positioned radially outward from the tapered surface, the tapered surface extending between the bowl and the flat outer surface such that the tapered surface contacts the bowl at a radially inward location and contacts the flat outer surface at a radially outward location.

10. The piston of claim 9, comprising a sidewall facing radially outward to mate with a cylinder of the engine.

11. The piston of claim 9, wherein the flat outer surface defines a plane that is perpendicular to a longitudinal piston axis that intersects a center of the bowl.

12. The piston of claim 9, wherein the radially inward location is a radially inward circumferential edge that is defined by the bowl and the tapered surface, and the radially outward location is a radially outward circumferential edge that is defined by the tapered surface and the flat outer surface.

13. The piston of claim 9, wherein the tapered surface is a frustoconical surface, and the frustoconical surface and the flat outer surface intersect so as to define the radially outward location.

14. An engine comprising the piston of claim 9.

15. The piston of claim 9, wherein:
the tapered surface is a frustoconical surface;
the radially inward location is a radially inward circumferential edge that is defined by the bowl and the tapered surface;
the radially outward location is a radially outward circumferential edge that is defined by the tapered surface and the flat outer surface;
the flat outer surface defines a plane that is perpendicular to a longitudinal piston axis that intersects a center of the bowl; and
the bowl comprises:
a conically curved section that comprises an inclined surface and a peak;
a recessed curved section positioned radially outward relative to the conically curved section, the inclined surface becomes gradually lower as it extends radially from the peak and radially toward the recessed curved section; and
a vertical wall section extending axially away from the recessed curved section such that the vertical wall section is in contact with the recessed curved section and in contact with the tapered surface.

16. The piston of claim 9, wherein the bowl faces axially upward, and the radially inward location is positioned axially below a peak of the bowl, as viewed in a central cross sectional view of the piston.

17. The piston of claim 16, wherein the radially outward location is positioned axially above the peak of the bowl, as viewed in the central cross sectional view of the piston.
